(19) United States
(12) Patent Application Publication
(10) Pub. No.: US 2024/0091643 A1
(43) Pub. Date: Mar. 21, 2024

(54) METHOD AND APPARATUS FOR CONTROLLING VIRTUAL OBJECTS IN GAME, AND ELECTRONIC DEVICE AND STORAGE MEDIUM

(71) Applicant: NETEASE (HANGZHOU) NETWORK CO., LTD.

(72) Inventors: Chao LUO, Hangzhou, Zhejiang (CN); Yuanyuan HOU, Hangzhou, Zhejiang (CN)

(21) Appl. No.: 18/266,165

(22) PCT Filed: Mar. 28, 2022
(86) PCT No.: PCT/CN2022/083495

§ 371 Date: Jun. 8, 2023

(30) Foreign Application Priority Data
Jun. 29, 2021 (CN) 202110726801.6

(51) Int. Cl. A63F 13/56; A63F 13/533

(52) U.S. Cl. CPC A63F 13/56; A63F 13/533

(57) ABSTRACT

An in-game virtual object control method including: providing, by a first terminal, a virtual object residence area on a graphical user interface of the first terminal, where a plurality of virtual objects to be selected are displayed in the virtual object resident area according to a trigger instruction; in response to a selection instruction for the plurality of virtual objects to be selected, selecting a target number of target virtual objects from the plurality of virtual objects to be selected, and adding the target number of target virtual objects into a virtual city; generating a demand task associated with at least one unselected virtual object to be selected, and displaying, on the graphical user interface, task information corresponding to the demand task; and completing the demand task, increasing the a preset duration for the virtual object to be selected to leave the virtual object residence area corresponding to the demand task.

### CROSS-REFERENCE TO RELATED APPLICATIONS

The present application is a National Stage Application of International Application No. PCT/CN2022/083495, filed on Mar. 28, 2022, which is based upon and claims priority to the Chinese Patent Application No. 202110726801.6 filed on Jun. 29, 2021 and entitled “IN-GAME VIRTUAL OBJECT CONTROL METHOD, APPARATUS, ELECTRONIC DEVICE AND STORAGE MEDIUM”, the entire content of both of which is hereby incorporated by reference for all purposes.

### TECHNICAL FIELD

The present disclosure relates to the technical field of gaming, and in particular, to an in-game virtual object control method and apparatus, an electronic device and a storage medium.

### BACKGROUND

The business simulation game is a type of electronic game in which the player plays the role of a manager who operates and manages a virtual reality world in the game, such that in the virtual world, the players are satisfied with the fun of free creation and obtain satisfaction through continuous task executing and upgrading.

### SUMMARY

The present disclosure provides an in-game virtual object control method and apparatus, an electronic device and a storage medium.

In a first aspect, an embodiment of the present disclosure provides an in-game virtual object control method, including: providing, by a first terminal, a virtual object residence area on a graphical user interface of the first terminal, where a plurality of virtual objects to be selected are displayed in the virtual object residence area according to a trigger instruction, and the plurality of virtual objects to be selected are configured to leave the virtual object residence area after a preset duration; in response to a selection instruction for the plurality of virtual objects to be selected, selecting a target number of target virtual objects from the plurality of virtual objects to be selected, and adding the target number of target virtual objects into a virtual city; generating a demand task associated with at least one virtual object to be selected that is unselected, and displaying, on the graphical user interface, task information corresponding to the demand task; and in response to completing the demand task, increasing the preset duration for one of the at least one virtual object to be selected to leave the virtual object residence area corresponding to the demand task.

In a second aspect, an embodiment of the present disclosure provides an electronic device including: a processor, a memory, configured to store an executable instruction by the processor, where the processor is configured to execute an in-game virtual object control method by executing the executable instruction, the method including: providing, by a first terminal, a virtual object residence area on a graphical user interface of the first terminal, where a plurality of virtual objects to be selected are displayed in the virtual object residence area according to a trigger instruction, and the plurality of virtual objects to be selected are configured to leave the virtual object residence area after a preset duration; in response to a selection instruction for the plurality of virtual objects to be selected, selecting a target number of target virtual objects from the plurality of virtual objects to be selected, and adding the target number of target virtual objects into a virtual city; generating a demand task associated with at least one virtual object to be selected that is unselected, and displaying, on the graphical user interface, task information corresponding to the demand task; and in response to completing the demand task, increasing the preset duration for one of the at least one virtual object to be selected to leave the virtual object residence area corresponding to the demand task.

In a third aspect, an embodiment of the present disclosure provides a non-transitory computer-readable storage medium, where the non-transitory storage medium stores thereon instruction that, when executed by a processor of an electronic device, cause the electronic device to perform operations of an in-game virtual object control method, the method including: providing, by a first terminal, a virtual object residence area on a graphical user interface of the first terminal, where a plurality of virtual objects to be selected are displayed in the virtual object residence area according to a trigger instruction, and the plurality of virtual objects to be selected are configured to leave the virtual object residence area after a preset duration; in response to a selection instruction for the plurality of virtual objects to be selected, selecting a target number of target virtual objects from the plurality of virtual objects to be selected, and adding the target number of target virtual objects into a virtual city; generating a demand task associated with at least one virtual object to be selected that is unselected, and displaying, on the graphical user interface, task information corresponding to the demand task; and in response to completing the demand task, increasing the preset duration for one of the at least one virtual object to be selected to leave the virtual object residence area corresponding to the demand task.

### BRIEF DESCRIPTION OF THE DRAWINGS

The accompanying drawings, which are incorporated in and constitute a part of this specification, illustrate examples consistent with the present disclosure and, together with the description, serve to explain the principles of the disclosure.

FIG. 1 is a schematic flowchart of an in-game virtual object control method according to an embodiment of the present disclosure;

FIG. 2 is a schematic diagram of a graphical user interface according to an embodiment of the present disclosure;

FIG. 3 is a schematic flowchart of an in-game virtual object control method according to an embodiment of the present disclosure;

FIG. 4 is a schematic flowchart of an in-game virtual object control method according to an embodiment of the present disclosure;

FIG. 5 is a schematic diagram of another graphical user interface according to an embodiment of the present disclosure;

FIG. 6 is a schematic flowchart of an in-game virtual object control method according to an embodiment of the present disclosure;

FIG. 7 is a schematic flowchart of an in-game virtual object control method according to an embodiment of the present disclosure;

FIG. 8 is a schematic flowchart of an in-game virtual object control method according to an embodiment of the present disclosure;

FIG. 9 is a schematic flowchart of an in-game virtual object control method according to an embodiment of the present disclosure;

FIG. 10 is a schematic diagram of still another graphical user interface according to an embodiment of the present disclosure;

FIG. 11 is a schematic diagram of yet another graphical user interface according to an embodiment of the present disclosure;

FIG. 12 is a schematic diagram of an in-game virtual object control apparatus according to an embodiment of the present disclosure; and

FIG. 13 is a schematic diagram of the structure of an electronic device according to an embodiment of the present disclosure.

### DETAILED DESCRIPTION

Reference will now be described in detail to examples, which are illustrated in the accompanying drawings. The following description refers to the accompanying drawings in which the same numbers in different drawings represent the same or similar elements unless otherwise represented. The examples described following do not represent all examples consistent with the present disclosure. Instead, they are merely examples of devices and methods consistent with aspects of the disclosure as detailed in the appended claims.

Terms used in the present disclosure are merely for describing specific examples and are not intended to limit the present disclosure. The singular forms “one”, “the”, and “this” used in the present disclosure and the appended claims are also intended to include a multiple form, unless other meanings are clearly represented in the context. It should also be understood that the term “and/or” used in the present disclosure refers to any or all of possible combinations including one or more associated listed items.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

It should be understood that although terms “first”, “second”, “third”, and the like are used in the present disclosure to describe various information, the information is not limited to the terms. These terms are merely used to differentiate information of a same type. For example, without departing from the scope of the present disclosure, first information is also referred to as second information, and similarly the second information is also referred to as the first information. Depending on the context, for example, the term “if” used herein may be explained as “when” or “while”, or “in response to . . . , it is determined that”.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

A unit or module may be implemented purely by software, purely by hardware, or by a combination of hardware and software. In a pure software implementation, for example, the unit or module may include functionally related code blocks or software components, that are directly or indirectly linked together, so as to perform a particular function.

In some urban population management games, buildings are usually constructed and maintained in a game scene to realize the development and expansion of the city. Virtual characters in the virtual city perform different works according to their own attributes. In addition, due to the limitation of city scale, there is a bottleneck in the number of virtual characters, which has an undesired impact on the operation of the virtual city.

In such games, in the process of controlling the virtual city, the diversity of population control in the virtual city is insufficient, and it is impossible to realize the control operation for the virtual city on the graphical user interface of a terminal to simulate and restore urban population control in the real world, resulting in poor user experience.

The in-game virtual object control method in one embodiment of the present disclosure may be operated in a terminal device or a server, where the terminal device may be a local terminal device. When the in-game virtual object control method is operated in the server, the method may be implemented and executed based on a cloud interaction system, where the cloud interaction system includes the server and a client device.

In an embodiment of the present disclosure, various cloud applications may be operated under the cloud interaction system, for example, a cloud game. By example of the cloud game, the cloud game refers to a game mode based on cloud computing. In the running mode of the cloud game, a main body for running a game program is separated from a main body for presenting a game screen (game picture), and the storage and operation of the in-game virtual object control method is completed on a cloud game server; the client device is configured to receive and send data and present the game screen, for example, the client device may be a display device with a data transmission function, close to the user side, such as a mobile terminal, a television, a computer, and a handheld computer. However, the terminal device performing information processing is the cloud game server in the cloud. When a game is played, a player operates the client device to send an operation instruction to the cloud game server, the cloud game server runs the game according to the operation instruction, codes and compresses data such as a game screen, and returns it to the client device through a network, and finally, the data are decoded through the client device and the game screen is outputted.

In an embodiment of the present disclosure, the terminal device may be a local terminal device. By example of a game, the local terminal device has game program(s) stored therein and is configured to present game screen(s). The local terminal device is configured to interact with the player through a graphical user interface, that is, conventionally download, install and run the game program through an electronic device. The manner in which the local terminal device provides the graphical user interface to the player may include various methods, for example, it may be displayed on a display screen of the terminal by rendering or is provided to the player by holographic projection. By way of example, the local terminal device may include a display screen and a processor, where the display screen is configured to present a graphical user interface including game screen(s), and the processor is configured to run the game, generate the graphical user interface, and control the display of the graphical user interface on the display screen.

An embodiment of the present disclosure provides an in-game virtual object control method, where a graphical user interface is provided by a first terminal device, and the first terminal device may be the aforementioned local terminal device, and may also be a client device in the aforementioned cloud interaction system.

Specific implementations of the in-game virtual object control method of the present disclosure will be described in detail as follow through a plurality of embodiments.

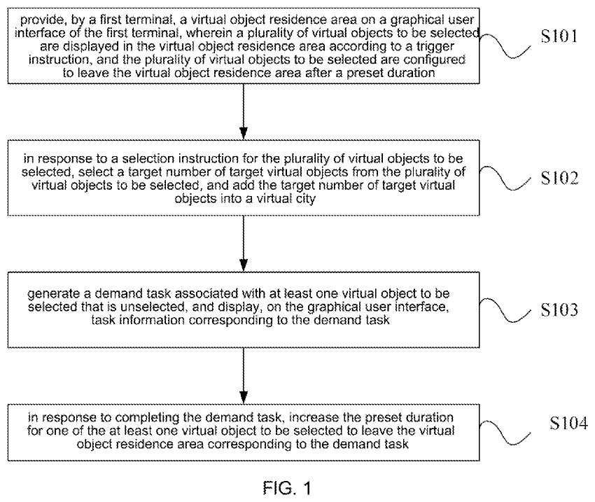

FIG. 1 is a first schematic flowchart of an in-game virtual object control method according to an embodiment of the present disclosure. As illustrated above, the graphical user interface is provided by the first terminal device, and a game scene of the corresponding game may be displayed in the graphical user interface. As shown in FIG. 1, the method may include:

S101. providing a virtual object residence area on the graphical user interface, where a plurality of virtual objects to be selected are displayed in the virtual object residence area according to a trigger instruction, and the plurality of virtual objects to be selected are set to leave the virtual object residence area after preset duration.

The game that the method is applied to may be a business simulation game. The management of refugees in a refugee camp in the game is taken as an example. Here, the virtual object residence area is the refugee camp in the game, and the virtual objects to be selected may refer to the virtual refugees to be managed by the player. The player can select the virtual refugees to enter the virtual city managed by itself, the virtual refugees may also provide demand tasks to the player to help the player to increase game experience and the like, and the scale of the virtual city of the player may be continuously expanded through the management of the virtual refugees, so that the player obtains a certain sense of achievement in the game.

The virtual object residence area may be a specific building within the virtual city, or may be a region within the virtual city. The virtual object residence area is configured to display a plurality of virtual objects to be selected, the player can input a trigger instruction through a preset control on the graphical user interface to display the plurality of virtual objects to be selected, or the system can automatically trigger the display of the plurality of virtual objects to be selected, after the player logs in the game. In the above, the virtual objects to be selected may be displayed in the form of avatar identification or name identification to distinguish different virtual objects. With being limited by the display range of the graphical user interface, the plurality of virtual objects to be selected are displayed in pages, and only part of virtual objects to be selected are displayed at a time, and all virtual objects to be selected can be viewed through a sliding operation.

It should be noted that there are two manners of generating the displayed virtual object to be selected in the virtual object residence area, one of which may be that the system randomly generates some virtual objects according to the trigger instruction and puts them in the virtual object residence area, and the other of which may be that the virtual objects rescued by the player during the gaming exploration are displayed in the virtual object residence area under the trigger instruction. Only two manners are exemplified here, and in the actual gaming design, virtual objects may be generated in other manners.

In some examples, each virtual object to be selected corresponds to a retention time, where the retention time may represent preset duration for the virtual object to leave the virtual object residence area, the preset duration may be dynamically and continuously decreased, and the virtual object to be selected may be selected by the player within the preset duration. The retention time for each virtual object to be selected may be automatically configured by the system.

S102. selecting, in response to a selection instruction for the plurality of virtual objects to be selected, a target number of target virtual objects from the plurality of virtual objects to be selected, and adding the target number of target virtual objects into a virtual city.

In some examples according to the present disclosure, the player can input a click operation for the identification of the virtual object to be selected displayed in the virtual object residence area so as to select the target virtual object; alternatively, the selection may be implemented by a circling operation, or the like.

In the above, the player may select a target number of target virtual objects from the plurality of virtual objects to be selected, and if the number of currently selected target virtual objects exceeds the target number, the subsequent selection is considered invalid.

In some examples, the selected target number of target virtual objects is considered to be added to the virtual city managed by the player, i.e., belonging to members in the virtual city managed by the player, and the virtual objects existing in the virtual city of one player will not exist in the virtual cities of the other players at the same time.

S103. generating at least one demand task associated with at least one unselected virtual object to be selected, and displaying task information corresponding to the at least one demand task on the graphical user interface.

In some embodiments, at least one demand task may be distributed to the virtual objects to be selected that are not selected by the player, i.e., that are still in the virtual object residence area, and the at least one demand task is used for the virtual object to be selected to make a demand on the player, thus increasing the retention time of the virtual objects to be selected, so that the duration for the virtual objects to be selected to stay in the virtual object residence area is prolonged, and meanwhile, more opportunities are provided for the player to select the virtual objects to be selected.

In some examples, the demand task of the virtual object to be selected may be displayed on the graphical user interface to inform the player that the demand task needs to be completed currently, where detailed task information corresponding to the demand task may be specifically displayed to instruct the player to complete the demand task according to the task information.

S104. increasing, in response to a completion event for the demand task, the preset duration for the virtual object to be selected, corresponding to the demand task, to leave the virtual object residence area.

In some examples, the player may complete the demand task according to the task information corresponding to the demand task. Similar to other battle games, after the demand task is completed, corresponding game reward may be obtained, so that the enthusiasm of the player for completing the task is stimulated, and the gaming experience is increased.

In an embodiment of the present disclosure, the game reward may be that the retention time of the virtual object to be selected corresponding to the demand task is increased, that is, the preset duration for the virtual object to be selected, corresponding to the demand task, to leave the virtual object residence area is prolonged. As described above, each virtual object to be selected has a corresponding associated demand task, and it should be noted that it is the retention time of the virtual object to be selected corresponding to the completed demand task that is increased here, and by increasing the retention time of the virtual object to be selected, that is, delaying the time for the virtual object to be selected to leave the virtual object residence area, more time can be gained for the player to select the virtual object to be selected to enter the virtual city, and the gaming enthusiasm of the player is stimulated.

In one example, the in-game virtual object control method provided by the present disclosure includes: providing a virtual object residence area on a graphical user interface, where a plurality of virtual objects to be selected are displayed in the virtual object residence area according to a trigger instruction, and the plurality of virtual objects to be selected are set to leave the virtual object residence area after preset duration; selecting, in response to a selection instruction for the plurality of virtual objects to be selected, a target number of target virtual objects from the plurality of virtual objects to be selected, and adding the target number of target virtual objects into a virtual city; generating at least one demand task associated with at least one unselected virtual object to be selected, and displaying task information corresponding to the demand task on the graphical user interface; and increasing, in response to a completion event for the demand task, preset duration for the virtual object to be selected corresponding to the demand task to leave the virtual object residence area. This method may help to solve the problems that the diversity of population control in the virtual city is insufficient, and that it is impossible to realize the control operation for the virtual city on the graphical user interface of a terminal to simulate and restore urban population control in the real world, resulting in poor user experience. By associating a demand task with an unselected virtual object to be selected in the virtual object residence area, the player can obtain rewards in a mode of completing the demand task; and by increasing preset duration for the virtual object to be selected to leave the virtual object residence area, i.e., delaying the time for the virtual object to be selected to leave, more opportunities for adding more virtual objects to be selected into the virtual city to expand the scale of the virtual city are gained. Through the method, continuous task execution motivations can be provided for the player, and the gaming enthusiasm of the game player is stimulated, so that the gaming experience is improved.

In some examples, in the step S102, the selecting in response to a selection instruction for the plurality of virtual objects to be selected a target number of target virtual objects from the plurality of virtual objects to be selected may include: selecting, in response to a selection instruction for the plurality of virtual objects to be selected, the target number of target virtual objects from the plurality of virtual objects to be selected, according to a pre-configured accommodated virtual population threshold of the virtual city.

In some embodiments, the virtual city of the player may have a fixed number of accommodated virtual population in a certain period of time, and there is an upper limit; and as the virtual objects to be selected continue to be added, the number of accommodated virtual population in the virtual city will gradually reach the threshold. In some examples, when a target number of target virtual objects is selected from the plurality of virtual objects to be selected, the target number of the target virtual objects may be selected according to a pre-configured accommodated virtual population threshold of the virtual city, so that the target number of the selected target virtual objects does not exceed the threshold, and the population capacity of the virtual city is prevented from exceeding the limit.

In some examples, in the step S102, the selecting in response to a selection instruction for the plurality of virtual objects to be selected a target number of target virtual objects from the plurality of virtual objects to be selected may include: selecting, in response to a selection instruction for a target virtual object inputted according to the attribute information of each virtual object to be selected, the target number of target virtual objects from the plurality of virtual objects to be selected, where the attribute information includes: work type, preset duration for leaving the virtual object residence area, personality description, and figure portrait.

In some embodiments, for a plurality of virtual objects to be selected displayed in the virtual object residence area, each virtual object to be selected further corresponds to respective attribute information, which may include: the work type of the virtual object to be selected, the preset duration for the virtual object to be selected to leave the virtual object residence area described above, the personality description and the figure portrait, where the work types may be, for example: workers, engineers, the elderly, children, and the like, the personality description refers to describing the virtual object to be selected through a concise sentence to characterize the object's personality, and the figure portrait may be a half-length portrait (half-body portrait), namely a virtual portrait, so as to show, to a player, the approximate appearance of the virtual object to be selected.

In some examples, the selected target virtual object may be allowed to enter the virtual city in an interactive form of clearance and stamping (sealing), and the specific implementation may be as follows: a stamping button is set, the player may click, after selecting the identification of the target virtual object, the stamping button to play the stamping animation. Other manifestation forms may further be adopted.

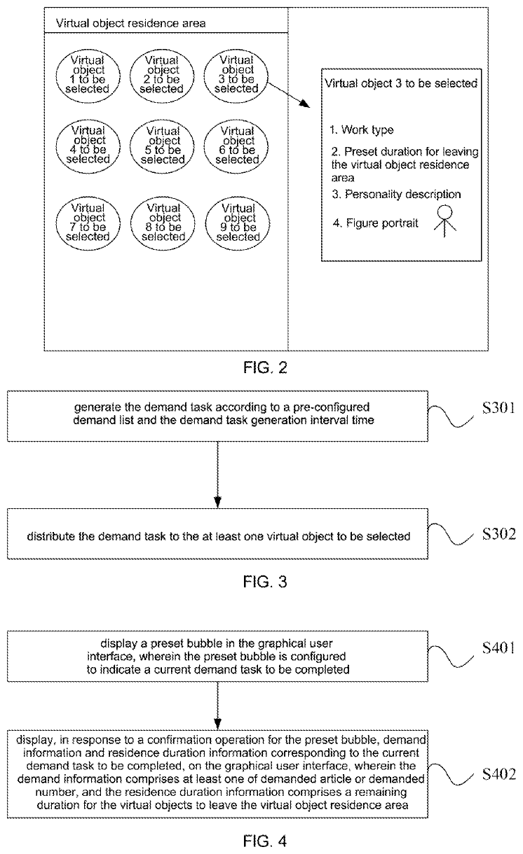

FIG. 2 is a schematic diagram of a graphical user interface according to an embodiment of the present disclosure. In some examples, the attribute information of each virtual object to be selected may be hidden, and when the mouse cursor or the touch medium is moved to any virtual object to be selected, the attribute information of the virtual object to be selected may be displayed correspondingly as shown in FIG. 2.

In an example of the present disclosure, the player may select a target virtual object from the plurality of virtual objects to be selected, according to the attribute information of each virtual object to be selected, where the attribute information can help the player make a more accurate selection, for example, according to the work type information, the contribution of the elderly and children to the virtual city is relatively small, and they may further increase the burden of the virtual city to a certain extent, so when the player makes a selection, most of them may be partial to the virtual objects to be selected who work as workers or engineers; and for the attribute information of the preset duration for the virtual objects to be selected to leave the virtual object residence area, in order to avoid a large loss of the virtual objects to be selected, relatively, the virtual objects to be selected with shorter preset duration may be selected first, so as to add the virtual objects to be selected to the virtual city in time.

The attribute information of each virtual object to be selected is vividly, specifically and more graphically displayed to the player, so that the player may be helped to make a more reasonable selection, to improve the level of the virtual city of the player, and improve the gaming experience of the player.

FIG. 3 is a second schematic flowchart of an in-game virtual object control method according to an embodiment of the present disclosure. In some examples, in the step S103, the generating at least one demand task associated with at least one unselected virtual object to be selected may include:

S301. generating at least one demand task according to a pre-configured demand list and demand task generation interval time.

In some examples, the demand list may include related information of a plurality of demand tasks to be created, and the demand list may be created by a developer itself during game development and stored locally in a server or a terminal, and may be called at any time during use.

In some embodiments, the plurality of demand tasks to be created in the demand list may be sequentially arranged according to priorities of the tasks, where for partial specialized demands with higher priority, these demands may be arranged at the front end of the demand list, or the specialized demands may be specially marked in the demand list to distinguish from the ordinary demands.

In addition, the demand task generation interval time may be preset, that is, after a demand task is generated, how long it takes to generate a next demand task. In the above, the demand task generation interval time may be configured according to the level of the virtual city of the player, where in one case, the higher the level of the virtual city is, the shorter the corresponding demand task generation interval time is. In this way, more demand tasks may be generated in the same time.

In some examples, the related information of the demand tasks to be created may be sequentially read from the demand list according to the determined demand task generation interval time above, so as to sequentially generate at least one demand task, where all the specialized demands may be traversed first, and after generation of the specialized demand tasks is completed, the related information of individual ordinary demand tasks may be sequentially read.

S302. distributing the at least one demand task to the at least one unselected virtual object to be selected.

In some examples, in one case, the demand task may be generated and simultaneously directly distributed to at least one unselected virtual object to be selected, that is, every time one demand task is generated, it is immediately distributed to one virtual object to be selected. In one case, after a batch of demand tasks are generated, the batch of demand tasks may also be uniformly distributed to at least one unselected virtual object to be selected, which is not limited by the present disclosure.

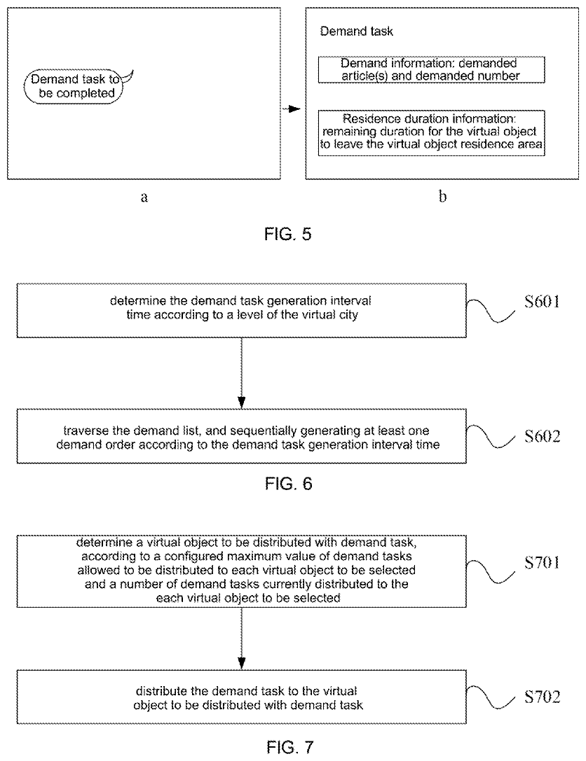

FIG. 4 is a third schematic flowchart of an in-game virtual object control method provided according to an embodiment of the present disclosure; and FIG. 5 is a schematic diagram of another graphical user interface according to an embodiment of the present disclosure. In some examples, in the step S103, the displaying task information corresponding to the demand task on the graphical user interface may include:

S401. displaying a preset bubble in the graphical user interface, where the preset bubble is configured to indicate a current demand task to be completed.

In some embodiments, after the demand task is distributed to the virtual object to be selected, a preset bubble pop-up window may further be displayed in the graphical user interface. As shown in a in FIG. 5, prompt information may be displayed in the preset bubble, which is used to prompt the player of the current demand tasks to be completed. Displaying in the form of a preset bubble is only one of the implementable modes. In practical applications, prompts may also be provided by setting a special message prompt bar, by highlighting and displaying the identification of the virtual object to be selected corresponding to the demand task, or the like.

S402. displaying, in response to a confirmation operation for the preset bubble, demand information and residence duration information corresponding to the demand task to be completed, on the graphical user interface, where the demand information includes: at least one demanded article and demanded number, and the residence duration information includes: remaining duration for the virtual object to leave the virtual object residence area.

In some examples, the player may view the demand tasks by inputting a confirmation operation for the preset bubble, where in response to the confirmation operation for the preset bubble, such as a click operation or a press operation, the interface shown in a in FIG. 5 may be jumped to the interface shown in b to display relevant information corresponding to the demand task to be completed, which includes: demand information and residence duration information. The demand information includes, but is not limited to: the name and number of articles demanded by the virtual object to be selected. The residence duration information includes: the remaining duration for the virtual object to be selected to leave the virtual object residence area.

It is worth noting that, in actual operation, all demand tasks to be completed may be prompted in the preset bubbles, and the individual demand tasks to be completed may be arranged in order according to the generation time, and the player may view the demand tasks in sequence and complete the demand tasks one by one.

FIG. 6 is a fourth schematic flowchart of an in-game virtual object control method according to an embodiment of the present disclosure. In some examples, in the step S301, the generating at least one demand task according to a pre-configured demand list and demand task generation interval time may include:

S601. determining the demand task generation interval time according to a level of the virtual city.

In some examples, when determining the demand task generation interval time, since the level of the virtual city is continuously increased, the determination may be performed according to the level of the virtual city currently in real time by the player, so as to ensure the accuracy of the determined demand task generation interval time.

S602. traversing the demand list, and sequentially generating at least one demand order according to the demand task generation interval time.

As described above, the specialized demand tasks may be traversed first to generate the special demand tasks first, and the remaining ordinary demand tasks may be traversed, read, and generated sequentially according to the arrangement in the list.

FIG. 7 is a fifth schematic flowchart of an in-game virtual object control method according to an embodiment of the present disclosure. In some examples, in the step S302, the distributing the at least one demand task to the at least one unselected virtual object to be selected may include:

S701. determining a virtual object to be distributed with demand task, according to the configured maximum value of demand tasks allowed to be distributed to each virtual object to be selected and the number of demand tasks currently distributed to the each virtual object to be selected.

In some embodiments, the demand tasks allowed to be distributed to each virtual object to be selected have an upper limit, so as to ensure the reasonableness of the game, and according to the number of the demand tasks currently distributed to each virtual object to be selected and the maximum value of the demand tasks allowed to be distributed to each virtual object to be selected, the virtual objects to be distributed with the demand tasks are determined from the unselected virtual objects to be selected, to be distributed with the demand tasks. In the above, the maximum values of the demand tasks allowed to be distributed to individual virtual object to be selected may be set to be the same, so that fairness is guaranteed.

S702. distributing the at least one demand task to the virtual object to be distributed with demand task.

In some examples, at least one demand task generated above may be distributed to the determined virtual object(s) to be distributed. In one way, every time one demand task is generated, it may be randomly distributed to any virtual object to be distributed with demand task; alternatively, a batch of demand tasks may be generated, and they may be uniformly and randomly distributed to a corresponding number of virtual objects to be distributed with the demand tasks.

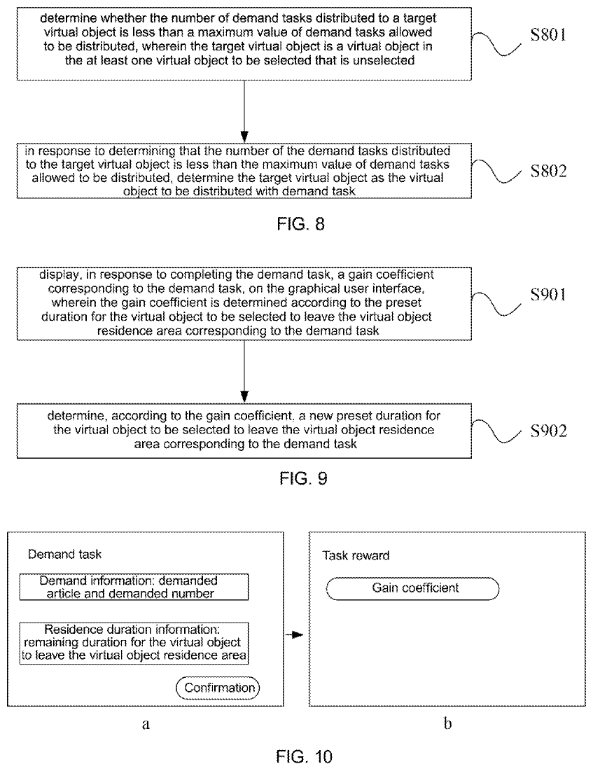

FIG. 8 is a sixth schematic flowchart of an in-game virtual object control method according to an embodiment of the present disclosure. In some examples, in the step S701, the determining a virtual object to be distributed with demand task according to the configured maximum value of demand tasks allowed to be distributed to each virtual object to be selected and the number of demand tasks currently distributed to the each virtual object to be selected may include:

S801. determining whether the number of demand tasks distributed to a target virtual object is less than the maximum value of demand tasks allowed to be distributed, where the target virtual object is any virtual object in the at least one unselected virtual object to be selected.

In some examples, for any unselected virtual object to be selected, it may be determined whether the number of currently distributed demand tasks is less than the maximum value of demand tasks allowed to be distributed, that is, whether the number of currently distributed demand tasks reaches an upper limit.

S802. determining, if yes, the target virtual object as the virtual object to be distributed with demand task.

If and only if the number of the demand tasks currently distributed to a virtual object to be selected does not reach the upper limit, the virtual object to be selected may be used as the virtual object to be distributed with demand task, and when the number of the demand tasks currently distributed to a virtual object to be selected has reached the upper limit, a new demand task is not distributed to the virtual object to be selected.

In some examples, the method of the present disclosure may further include: discarding the currently generated demand task, if the number of demand tasks currently distributed to the at least one unselected virtual object to be selected reaches the maximum value of demand tasks allowed to be distributed.

In some embodiments, when the number of demand tasks currently distributed to all unselected virtual objects to be selected in the virtual object residence area reaches the maximum value of the demand tasks allowed to be distributed, that is, the number reaches the upper limit, at this time, a newly generated demand task cannot be distributed to the virtual objects to be selected, and the demand task that cannot be distributed may be discarded, that is, considered invalid.

In some examples, after the step of discarding the currently generated demand task described above, the method of the present disclosure may further include: stopping generating a demand task until a new virtual object to be selected is generated in the virtual object residence area.

When the above generated demand task is discarded, the system does not generate the demand task any more so as to avoid invalid data processing, until a new virtual object to be selected is added into the virtual object residence area, then the generation of the demand task may be resumed.

FIG. 9 is a seventh schematic flowchart of an in-game virtual object control method according to an embodiment of the present disclosure; and FIG. 10 is a schematic diagram of still another graphical user interface according to an embodiment of the present disclosure. In some examples, in the step S104, the increasing in response to a completion event for the demand task preset duration for the virtual object to be selected corresponding to the demand task to leave the virtual object residence area may include:

S901. displaying, in response to the completion event for the demand task, a gain coefficient corresponding to the demand task, on the graphical user interface, where the gain coefficient is determined according to preset duration for the virtual object to be selected, corresponding to the demand task, to leave the virtual object residence area.

Based on the interface shown in b in FIG. 5, as shown in a in FIG. 10, while task information corresponding to the demand task is displayed, a confirmation control is further displayed, and the inputted confirmation operation through the confirmation control may be responded to complete the demand task.

In some examples, in response to a completion event fora demand task, the interface shown as a in FIG. 10 may jump to a task reward interface shown as b in FIG. 10, where a gain coefficient corresponding to the demand task may be displayed. The gain coefficient may refer to a gain coefficient of preset duration for the virtual object to be selected to leave the virtual object residence area, and the gain coefficient may be equivalent to a percentage addition (percentage bonus) of initially configured preset duration for the virtual object to be selected to leave the virtual object residence area. In the above, the displayed gain coefficient refers to a gain coefficient for a virtual object to be selected corresponding to the currently completed demand task, and the gain coefficients of different virtual objects to be selected are different.

S902. determining, according to the gain coefficient, new preset duration for the virtual object to be selected, corresponding to the demand task, to leave the virtual object residence area.

In some examples, a new preset duration for the virtual object to be selected corresponding to the demand task to leave the virtual object residence area may be calculated according to the gain coefficient, so that the new preset duration is used as a determination condition for the virtual object to be selected to leave the virtual object residence area. Assuming that the initially configured preset duration for the virtual object to be selected to leave the virtual object residence area is 60 minutes, the current remaining duration that the virtual object to be selected leaves the virtual object residence area is 20 minutes, and the gain coefficient obtained through calculation is 0.4, then the new preset duration for the virtual object to be selected to leave the virtual object residence area may be: 20+60*0.4, that is, the added duration is added to the current remaining duration.

In some examples, the method of the present disclosure may further include: generating a task reward, in response to a completion event for the demand task, where the task reward includes: at least one virtual prop and game experience.

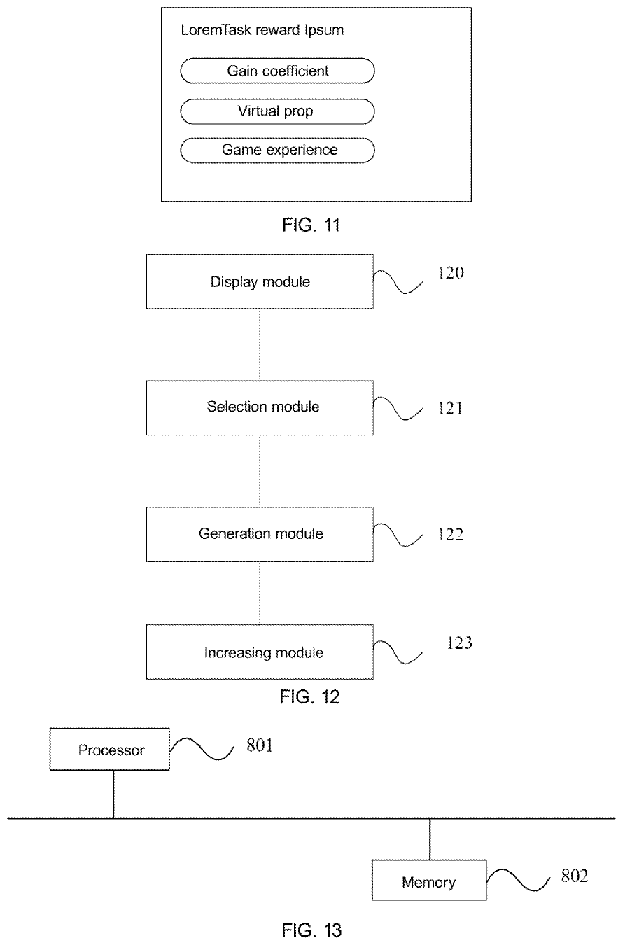

FIG. 11 is a schematic diagram of yet another graphical user interface according to an embodiment of the present disclosure. Based on the task reward interface shown in b in FIG. 10, as shown in FIG. 11, after the task demand is completed, other task rewards may further be displayed in the task reward interface, such as: the addition of virtual prop(s) or the addition of game experience, and there may be other types of rewards besides the listed task rewards, for example, player rating promotion and skin reward, etc. The gaming enthusiasm of the player may be improved to a certain extent through the form of the task reward.

In some examples, in the step S101, the plurality of virtual objects to be selected being set to leave the virtual object residence area after preset duration may include: if the virtual object to be selected is not selected within the preset duration, deleting the virtual object to be selected from the virtual object residence area.

In some embodiments, for the unselected virtual object to be selected in the virtual object residence area, when the virtual object to be selected is not selected by the player within the configured retention time, the virtual object to be selected is deleted from the virtual object residence area, that is, the virtual object to be selected is lost, and the deleted virtual object to be selected may continue to be a member of the virtual object residence area of other players.

In some examples, the method of the present disclosure may further include: in response to receiving a virtual city expansion instruction, increasing an accommodated virtual population threshold of the virtual city.

Since the scale of the virtual city of the player needs to be continuously expanded, the number of the accommodated virtual objects to be selected needs to be continuously increased by dynamically expanding the virtual city, so that the virtual city is expanded step by step.

In some examples, the expansion of the virtual city is not randomly performed, and may be performed according to a preset time interval, where the preset time interval may be configured during game development. Alternatively, the expansion of the virtual city may be triggered based on the resources and building capabilities owned by the player.

In response to an expansion instruction for the virtual city, an increase in the accommodated virtual population threshold of the virtual city may be triggered. In the above, the expansion instruction for the virtual city may include, but is not limited to, a promotion in the level of the virtual city, an increase in the number of virtual houses, the number of virtual foods exceeding a threshold, a city science and technology index exceeding a threshold, and the like.

In some examples, the method of the present disclosure may further include: in response to receiving a rescue operation for a virtual object in a game scene, adding the rescued virtual object to the virtual object residence area.

As mentioned above, the virtual objects to be selected generated in the virtual object residence area may be generated in the form of automatic system delivery, or may be virtual objects that have been rescued by the player during the exploration. In some examples, in response to a rescue operation for the virtual object, the rescued virtual object may be displayed in the virtual object residence area.

The in-game virtual object control method provided by the present disclosure includes: providing a virtual object residence area on a graphical user interface, where a plurality of virtual objects to be selected is displayed in the virtual object residence area according to a trigger instruction, and the plurality of virtual objects to be selected are set to leave the virtual object residence area after preset duration; selecting, in response to a selection instruction for the plurality of virtual objects to be selected, a target number of target virtual objects from the plurality of virtual objects to be selected, and adding the target number of target virtual objects into a virtual city; generating at least one demand task associated with at least one unselected virtual object to be selected, and displaying on the graphical user interface task information corresponding to the demand task; and increasing, in response to a completion event for the demand task, the preset duration for the virtual object to be selected, corresponding to the demand task, to leave the virtual object residence area. This solution solves the problems that the diversity of population control in the virtual city is insufficient, and that it is impossible to realize the control operation for the virtual city on the graphical user interface of a terminal to simulate and restore urban population control in the real world, resulting in poor user experience. By associating a demand task with an unselected virtual object to be selected in the virtual object residence area, the player can obtain rewards in a mode of completing the demand task; by increasing preset duration for the virtual object to be selected to leave the virtual object residence area, i.e., delaying the time for the virtual object to be selected to leave, more opportunities for adding into the virtual city more virtual objects to be selected to expand the scale of the virtual city are gained. Through the method, continuous (endless) task execution motivations can be provided for the player, and the gaming enthusiasm of the game player is stimulated, so that the gaming experience is improved.

In addition, by graphically displaying, to the player, attribute information of the virtual objects to be selected, the player can more reasonably select the virtual object(s) to be selected to join the virtual city according to the attribute information, so that the gaming experience of the player is improved.

The following describes an apparatus, a device and a storage medium for executing the in-game virtual object control method according to the present disclosure, and specific implementation process and technical effects thereof are referred to above and will not be described in detail below.

FIG. 12 is a schematic diagram of an in-game virtual object control apparatus according to an embodiment of the present disclosure, and the functions realized by the in-game virtual object control apparatus correspond to the steps performed by the method above. The apparatus may be construed as the first terminal described above. As shown in FIG. 12, the apparatus may include: a display module 120, a selection module 121, a generation module 122, and an increasing module 123;
where the display module 120 is configured to provide a virtual object residence area on the graphical user interface, where a plurality of virtual objects to be selected are displayed in the virtual object residence area according to a trigger instruction, and the plurality of virtual objects to be selected are set to leave the virtual object residence area after preset duration;
the selection module 121 is configured to select, in response to a selection instruction for the plurality of virtual objects to be selected, a target number of target virtual objects from the plurality of virtual objects to be selected, and add the target number of target virtual objects into a virtual city;
the generation module 122 is configured to generate at least one demand task associated with at least one unselected virtual object to be selected, and display task information corresponding to the demand task on the graphical user interface; and
the increasing module 123 is configured to increase, in response to a completion event for the demand task, preset duration for the virtual object to be selected, corresponding to the demand task, to leave the virtual object residence area.

In some examples, the selection module 121 is specifically configured to select, in response to a selection instruction for the plurality of virtual objects to be selected, the target number of target virtual objects from the plurality of virtual objects to be selected, according to a pre-configured accommodated virtual population threshold of the virtual city.

In some examples, the selection module 121 is specifically configured to select, in response to a selection instruction for a target virtual object inputted according to the attribute information of each virtual object to be selected, the target number of target virtual objects from the plurality of virtual objects to be selected, where the attribute information includes: work type, preset duration for leaving the virtual object residence area, personality description, and figure portrait.

In some examples, the generation module 122 is specifically configured to generate at least one demand task according to a pre-configured demand list and demand task generation interval time; and distribute the at least one demand task to a virtual object to be distributed with demand task.

In some examples, the generation module 122 is specifically configured to display a preset bubble in the graphical user interface, where the preset bubble is configured to indicate a current demand task to be completed; and display, in response to a confirmation operation for the preset bubble, demand information and residence duration information corresponding to the demand task to be completed, on the graphical user interface, where the demand information includes: the demanded article and the demanded number, and the residence duration information includes: remaining duration for the virtual object to leave the virtual object residence area.

In some examples, the generation module 122 is specifically configured to determine the demand task generation interval time according to a level of the virtual city; and traverse the demand list, and sequentially generate at least one demand order according to the demand task generation interval time.

In some examples, the generation module 122 is specifically configured to determine the virtual object to be distributed with demand task, according to the configured maximum value of demand tasks allowed to be distributed to each virtual object to be selected and the number of demand tasks currently distributed to each virtual object to be selected; and distribute at least one demand task to the virtual object to be distributed with demand task.

In some examples, the generation module 122 is specifically configured to determine whether the number of demand tasks distributed to a target virtual object is less than the maximum value of demand tasks allowed to be distributed, where the target virtual object is any virtual object in at least one unselected virtual object to be selected; and determine, if yes, the target virtual object as the virtual object to be distributed with demand task.

In some examples, the apparatus further includes: a discarding module,
the discarding module being configured to discard the currently generated demand task if the number of demand tasks currently distributed to the at least one unselected virtual object to be selected reaches the maximum value of demand tasks allowed to be distributed.

In some examples, the apparatus further includes: a stopping module;
the stopping module being configured to stop generating a demand task until a new virtual object to be selected is generated in the virtual object residence area.

In some examples, the increasing module 123 is specifically configured to display, in response to a completion event for the demand task, a gain coefficient corresponding to the demand task, on the graphical user interface, where the gain coefficient is determined according to preset duration for the virtual object to be selected, corresponding to the demand task, to leave the virtual object residence area; and determine, according to the gain coefficient, new preset duration for the virtual object to be selected, corresponding to the demand task, to leave the virtual object residence area.

In some examples, the generation module 122 is further configured to generate a task reward in response to the completion event for the demand task, where the task reward includes: the virtual prop and game experience.

In some examples, the apparatus further includes: a deletion module;
the deletion module being configured to delete, from virtual object residence area, the virtual object to be selected if the virtual object to be selected is not selected within the preset duration.

In some examples, the apparatus further includes: an expansion module;
the expansion module being configured to increase, in response to a received virtual city expansion instruction, an accommodated virtual population threshold of the virtual city.

In some examples, the display module 120 is specifically configured to add, in response to a received rescue operation for a virtual object in a game scene, the rescued virtual object to the virtual object residence area.

The apparatus described above is configured to perform the method according to the aforementioned embodiments, and the implementation principle and technical effects thereof are similar and will not be described in detail here.

The above modules may be one or more integrated circuits configured to implement the above methods, for example, one or more application specific integrated circuits (ASIC for short), or one or more microprocessors (digital signal processors, DSP for short), or one or more field programmable gate arrays (FPGA for short), or the like. For another example, when one of the above modules is implemented in the form of a processing element scheduling program codes, the processing element may be a general-purpose processor, for example, a central processing unit (CPU for short) or other processors capable of calling program codes. For still another example, these modules may be integrated together and implemented in the form of a system-on-a-chip (SOC).

The above described modules may be connected or in communication with each other via a wired connection or a wireless connection. The wired connection may include connection via a metal cable, an optical cable, a hybrid cable or the like, or any combination thereof. The wireless connection may include connection via a LAN, WAN, Bluetooth, ZigBee, NFC or the like, or any combination thereof. Two or more modules may be combined into a single module, and any one module may be divided into two or more units. It can be clearly understood by those skilled in the art that, for convenience and concision of description, the specific working process of the system and the apparatus described above may refer to the corresponding process in the method embodiment, which will not be described in the present disclosure.

It should be noted that the above modules may be one or more integrated circuits configured to implement the above methods, such as one or more application specific integrated circuits (ASIC for short), or one or more microprocessors (digital signal processors, DSP for short), or one or more field programmable gate arrays (FPGA for short), or the like. For another example, when one of the above modules is implemented in the form of a processing element scheduling program codes, the processing element may be a general-purpose processor, for example, a central processing unit (CPU for short) or other processors capable of calling program codes. For still another example, these modules may be integrated together and implemented in the form of a system-on-a-chip (SOC).

FIG. 13 is a schematic diagram of the structure of an electronic device according to an embodiment of the present disclosure. The device may be the first terminal device, where the first terminal device may be a local terminal device, and may also be a client device in the cloud interaction system.

The device may include: a processor 801 and a memory 802.

The memory 802 is configured to store the program, and the processor 801 is configured to call the program stored in the memory 802 to execute the steps of the above method embodiments:
providing a virtual object residence area on the graphical user interface, where a plurality of virtual objects to be selected are displayed in the virtual object residence area according to a trigger instruction, and the plurality of virtual objects to be selected are set to leave the virtual object residence area after preset duration;
selecting, in response to a selection instruction for the plurality of virtual objects to be selected, a target number of target virtual objects from the plurality of virtual objects to be selected, and adding the target number of target virtual objects into a virtual city;
generating at least one demand task associated with at least one unselected virtual object to be selected, and displaying task information corresponding to the demand task, on the graphical user interface; and
increasing, in response to a completion event for the demand task, preset duration for the virtual object to be selected, corresponding to the demand task, to leave the virtual object residence area.

In some examples, the selecting in response to a selection instruction for the plurality of virtual objects to be selected a target number of target virtual objects from the plurality of virtual objects to be selected includes:
selecting, in response to a selection instruction for the plurality of virtual objects to be selected, a target number of target virtual objects from the plurality of virtual objects to be selected according to a pre-configured accommodated virtual population threshold of the virtual city.

In some examples, the selecting in response to a selection instruction for the plurality of virtual objects to be selected a target number of target virtual objects from the plurality of virtual objects to be selected includes:
selecting, in response to a selection instruction for a target virtual object inputted according to the attribute information of each virtual object to be selected, the target number of target virtual objects from the plurality of virtual objects to be selected, where the attribute information includes: work type, preset duration for leaving the virtual object residence area, personality description, and figure portrait.

In some examples, the generating at least one demand task associated with at least one unselected virtual object to be selected includes:
generating at least one demand task according to a pre-configured demand list and demand task generation interval time; and
distributing the at least one demand task to the at least one unselected virtual object to be selected.

In some examples, the displaying task information corresponding to the demand task on the graphical user interface includes:
displaying a preset bubble in the graphical user interface, where the preset bubble is configured to indicate a current demand task to be completed; and
displaying, in response to a confirmation operation for the preset bubble, demand information and residence duration information corresponding to the demand task to be completed, on the graphical user interface, where the demand information includes: the demanded article and demanded number, and the residence duration information includes: remaining duration for the virtual object to leave the virtual object residence area.

In some examples, the generating at least one demand task according to a pre-configured demand list and demand task generation interval time includes:
determining the demand task generation interval time according to a level of the virtual city; and
traversing the demand list, and sequentially generating at least one demand order according to the demand task generation interval time.

In some examples, the distributing the at least one demand task to the at least one unselected virtual object to be selected includes:
determining a virtual object to be distributed with demand task, according to the configured maximum value of demand tasks allowed to be distributed to each virtual object to be selected and the number of demand tasks currently distributed to each virtual object to be selected; and
distributing the at least one demand task to the virtual object to be distributed with demand task.

In some examples, the determining a virtual object to be distributed with demand task according to the configured maximum value of demand tasks allowed to be distributed to each virtual object to be selected and the number of demand tasks currently distributed to each virtual object to be selected includes:
determining whether the number of demand tasks distributed to a target virtual object is less than the maximum value of demand tasks allowed to be distributed, where the target virtual object is any virtual object in the at least one unselected virtual object to be selected; and
determining, if yes, the target virtual object as the virtual object to be distributed with demand task.

In some examples, the method further includes:
discarding the currently generated demand task, if the number of demand tasks currently distributed to the at least one unselected virtual object to be selected reaches the maximum value of demand tasks allowed to be distributed.

In some examples, after the discarding the currently generated demand task, the method further includes:
stopping generating a demand task until the new virtual object to be selected is generated in the virtual object residence area.

In some examples, the increasing in response to a completion event for the demand task preset duration for the virtual object to be selected corresponding to the demand task to leave the virtual object residence area includes:
displaying, in response to the completion event for the demand task, a gain coefficient corresponding to the demand task, on the graphical user interface, where the gain coefficient is determined according to preset duration for the virtual object to be selected, corresponding to the demand task, to leave the virtual object residence area; and
determining, according to the gain coefficient, new preset duration for the virtual object to be selected, corresponding to the demand task, to leave the virtual object residence area.

In some examples, the method further includes:
generating a task reward, in response to a completion event for the demand task, where the task reward includes: the virtual prop and game experience.

In some examples, the plurality of virtual objects to be selected being set to leave the virtual object residence area after preset duration includes:
deleting, if the virtual object to be selected is not selected within the preset duration, the virtual object to be selected, from the virtual object residence area.

In some examples, the method further includes:
increasing, in response to a received virtual city expansion instruction, an accommodated virtual population threshold of the virtual city.

In some examples, the method further includes:
adding, in response to a received rescue operation for a virtual object in a game scene, the rescued virtual object to the virtual object residence area.

By associating a demand task with an unselected virtual object to be selected in the virtual object residence area, the player can obtain rewards in a mode of completing the demand task; by increasing preset duration for the virtual object to be selected to leave the virtual object residence area, i.e., delaying the time for the virtual object to be selected to leave, more opportunities for adding into the virtual city more virtual objects to be selected to expand the scale of the virtual city are gained. Through the above method, continuous task execution motivations can be provided for the player, and the gaming enthusiasm of the game player is stimulated, so that the gaming experience is improved. In addition, by graphically displaying to the player attribute information of the virtual object to be selected, the player can more reasonably select the virtual object to be selected to join the virtual city according to the attribute information, so that the gaming experience of the player is improved.

The specific implementation and technical effects are similar and will not be described in detail here.

In the above, the memory 802 stores program codes that, when executed by the processor 801, cause the processor 801 to perform various steps in methods according to various exemplary embodiments of the present disclosure described in the above “exemplary methods” section in the specification.

The processor 801 may be a general-purpose processor, such as a central processing unit (CPU), a digital signal processor (DSP), an application specific integrated circuit (ASIC), a field programmable gate array (FPGA) or other programmable logic devices, discrete gates or transistor logic devices, and discrete hardware components, which may implement or perform various methods, steps, and logic blocks disclosed in the embodiments of the present disclosure. The general-purpose processor may be a microprocessor, or any conventional processor, or the like. The steps of the methods disclosed in the embodiments of the present disclosure may be directly performed by a hardware processor, or implemented by a combination of hardware and software modules in the processor.

The memory 802, as a non-volatile computer-readable storage medium, may be configured to store non-volatile software programs, non-volatile computer-executable programs and modules. The memory may include at least one type of storage medium, for example, it may include a flash memory, a hard disk, a multi-media card, a card-type memory, a random access memory (RAM), a static random access memory (SRAM), a programmable read only memory (PROM), a read only memory (ROM), an electrically erasable programmable read-only memory (EEPROM), a magnetic memory, a magnetic disk, an optical Disk, and the like. The memory is any other medium that can be used to carry or store desired program codes in the form of instructions or data structures and that can be accessed by a computer, but is not limited to thereto. The memory 802 in the embodiments of the present disclosure may also be a circuit or any other apparatus capable of implementing a storage function for storing program instructions and/or data.

In some examples, the present disclosure further provides a program product, for example, a computer-readable storage medium, including programs which, when executed by a processor, are used to perform the steps of the above method embodiments:
providing a virtual object residence area on the graphical user interface, where a plurality of virtual objects to be selected are displayed in the virtual object residence area according to a trigger instruction, and the plurality of virtual objects to be selected are set to leave the virtual object residence area after preset duration;
selecting, in response to a selection instruction for the plurality of virtual objects to be selected, a target number of target virtual objects from the plurality of virtual objects to be selected, and adding the target number of target virtual objects into a virtual city;
generating at least one demand task associated with at least one unselected virtual object to be selected, and displaying, on the graphical user interface, task information corresponding to the demand task; and
increasing, in response to a completion event for the demand task, preset duration for the virtual object to be selected, corresponding to the demand task, to leave the virtual object residence area.

In some examples, the selecting in response to a selection instruction for the plurality of virtual objects to be selected a target number of target virtual objects from the plurality of virtual objects to be selected includes:
selecting, in response to a selection instruction for the plurality of virtual objects to be selected, a target number of target virtual objects from the plurality of virtual objects to be selected, according to a pre-configured accommodated virtual population threshold of the virtual city.

In some examples, the selecting in response to a selection instruction for the plurality of virtual objects to be selected a target number of target virtual objects from the plurality of virtual objects to be selected includes:
selecting, in response to a selection instruction for a target virtual object inputted according to the attribute information of each virtual object to be selected, the target number of target virtual objects from the plurality of virtual objects to be selected, where the attribute information includes: work type, preset duration for leaving the virtual object residence area, personality description, and figure portrait.

In some examples, the generating at least one demand task associated with at least one unselected virtual object to be selected includes:
generating at least one demand task according to a pre-configured demand list and demand task generation interval time; and
distributing the at least one demand task to the at least one unselected virtual object to be selected.

In some examples, the displaying task information corresponding to the demand task on the graphical user interface includes:
displaying a preset bubble in the graphical user interface, where the preset bubble is configured to indicate a current demand task to be completed; and
displaying, in response to a confirmation operation for the preset bubble, demand information and residence duration information corresponding to the demand task to be completed, on the graphical user interface, where the demand information includes: the demanded article and demanded number, and the residence duration information includes: remaining duration for the virtual object to leave the virtual object residence area.

In some examples, the generating at least one demand task according to a pre-configured demand list and demand task generation interval time includes:
determining the demand task generation interval time according to a level of the virtual city; and
traversing the demand list, and sequentially generating at least one demand order according to the demand task generation interval time.

In some examples, the distributing the at least one demand task to the at least one unselected virtual object to be selected includes:
determining a virtual object to be distributed with demand task, according to the configured maximum value of demand tasks allowed to be distributed to each virtual object to be selected and the number of demand tasks currently distributed to each virtual object to be selected; and
distributing the at least one demand task to the virtual object to be distributed with demand task.

In some examples, the determining a virtual object to be distributed with demand task according to the configured maximum value of demand tasks allowed to be distributed to each virtual object to be selected and the number of demand tasks currently distributed to each virtual object to be selected includes:
determining whether the number of demand tasks distributed to a target virtual object is less than the maximum value of demand tasks allowed to be distributed, where the target virtual object is any virtual object in the at least one unselected virtual object to be selected; and
determining, if yes, the target virtual object as the virtual object to be distributed with demand task.

In some examples, the method further includes:
discarding the currently generated demand task, if the number of demand tasks currently distributed to the at least one unselected virtual object to be selected reaches the maximum value of demand tasks allowed to be distributed with the demand task.

In some examples, after the discarding the currently generated demand task, the method further includes:
stopping generating a demand task until the new virtual object to be selected is generated in the virtual object residence area.

In some examples, the increasing in response to a completion event for the demand task preset duration for the virtual object to be selected corresponding to the demand task to leave the virtual object residence area includes:
displaying, in response to a completion event for the demand task, a gain coefficient corresponding to the demand task, on the graphical user interface, where the gain coefficient is determined according to preset duration for the virtual object to be selected, corresponding to the demand task, to leave the virtual object residence area; and
determining, according to the gain coefficient, new preset duration for the virtual object to be selected, corresponding to the demand task, to leave the virtual object residence area.

In some examples, the method further includes:
generating a task reward, in response to a completion event for the demand task, where the task reward includes: the virtual prop and game experience.

In some examples, the plurality of virtual objects to be selected being set to leave the virtual object residence area after preset duration includes:
deleting, if the virtual object to be selected is not selected within the preset duration, the virtual object to be selected, from the virtual object residence area.

In some examples, the method further includes:
increasing, in response to a received virtual city expansion instruction, an accommodated virtual population threshold of the virtual city.

In some examples, the method further includes:
adding, in response to a received rescue operation for a virtual object in a game scene, the rescued virtual object to the virtual object residence area.

By associating a demand task with an unselected virtual object to be selected in the virtual object residence area, the player can obtain rewards in a mode of completing the demand task; and by increasing preset duration for the virtual object to be selected to leave the virtual object residence area, i.e., delaying the time for the virtual object to be selected to leave, more opportunities for adding into the virtual city more virtual objects to be selected to expand the scale of the virtual city are gained. Through the above method, continuous task execution motivations can be provided for the player, and the gaming enthusiasm of the game player is stimulated, so that the gaming experience is improved. In addition, by graphically displaying, to the player, attribute information of the virtual object to be selected, the player can more reasonably select the virtual object to be selected to join the virtual city according to the attribute information, so that the gaming experience of the player is improved.

The present disclosure provides an in-game virtual object control method and apparatus, an electronic device and a storage medium, where the method includes: providing a virtual object residence area on a graphical user interface, where a plurality of virtual objects to be selected are displayed in the virtual object residence area according to a trigger instruction, and the plurality of virtual objects to be selected are set to leave the virtual object residence area after preset duration; selecting, in response to a selection instruction for the plurality of virtual objects to be selected, a target number of target virtual objects from the plurality of virtual objects to be selected, and adding the target number of target virtual objects into a virtual city; generating at least one demand task associated with at least one unselected virtual object to be selected, and displaying task information corresponding to the at least one demand task on the graphical user interface; and increasing, in response to a completion event for one of the at least one demand task, the preset duration for one of the at least one virtual object to be selected, corresponding to the demand task, to leave the virtual object residence area. This solution may solve the problems that the diversity of population control in the virtual city is insufficient and it is impossible to realize the control operation for the virtual city on the graphical user interface of a terminal to simulate and restore urban population control in the real world, resulting in poor user experience. By associating the demand task with the unselected virtual object to be selected in the virtual object residence area, the player can obtain rewards in a mode of completing the demand task; and by increasing preset duration for the virtual objects to be selected to leave the virtual object residence area, the time for the virtual objects to be selected to leave is delayed, gaining more opportunities for adding more virtual objects to be selected into the virtual city to expand the scale of the virtual city. Through the method, continuous task execution motivations can be provided for the player, and the gaming enthusiasm of the game player is stimulated, so that the gaming experience is improved.

In addition, by graphically displaying, to the player, attribute information of the virtual objects to be selected, the player can more reasonably select, according to the attribute information, the virtual objects to be selected, to join the virtual city, so that the gaming experience of the player is improved.

In the several embodiments provided in the present disclosure, it should be understood that the disclosed apparatus and method may be implemented in other manners. For example, the above described apparatus embodiments are merely illustrative, and for example, the division of the units is only one type of logical functional division, and other divisions may be achieved in practical use. For example, a plurality of units or components may be combined or integrated into another system, or some features may be omitted or not performed. In addition, the shown or discussed mutual coupling or direct coupling or communication connection may be an indirect coupling or communication connection through some interfaces, apparatuses or units, and may be in an electrical, mechanical or other form.

The units described as separate parts may be or may not be physically separate, and parts displayed as units may be or may not be physical units, that is, may be located in one place or may be distributed in a plurality of network units. Some or all of the units may be selected according to actual needs to achieve the purposes of the solutions of the embodiment.

In addition, the individual functional units in the embodiments of the present disclosure may be integrated into one processing unit, or each unit may exist alone physically, or two or more units are integrated into one unit. The above integrated unit may be achieved in the form of hardware, and may also be achieved in the form of hardware plus a software functional unit.

The above integrated unit implemented in the form of a software functional unit may be stored in a computer-readable storage medium. The above software functional unit is stored in a storage medium and includes several instructions for enabling a computer device (which can be a personal computer, a server, a network device or the like) or a processor to implement all or part of the steps of the method described in the embodiments of the present disclosure. The aforementioned storage medium includes a U-disk, a mobile hard disk, a read-only memory (ROM for short), a random access memory (RAM for short), a magnetic disk, an optical disk, or other media capable of storing program codes.

1. An in-game virtual object control method, comprising:
providing, by a first terminal, a virtual object residence area on a graphical user interface of the first terminal, wherein a plurality of virtual objects to be selected are displayed in the virtual object residence area according to a trigger instruction, and the plurality of virtual objects to be selected are configured to leave the virtual object residence area after a preset duration;
in response to a selection instruction for the plurality of virtual objects to be selected, selecting a target number of target virtual objects from the plurality of virtual objects to be selected, and adding the target number of target virtual objects into a virtual city;
generating a demand task associated with at least one virtual object to be selected that is unselected, and displaying, on the graphical user interface, task information corresponding to the demand task; and
in response to completing the demand task, increasing the preset duration for one of the at least one virtual object to be selected to leave the virtual object residence area corresponding to the demand task.

2. The method according to claim 1, wherein in response to the selection instruction for the plurality of virtual objects to be selected, selecting the target number of target virtual objects from the plurality of virtual objects to be selected comprises:
selecting, in response to the selection instruction for the plurality of virtual objects to be selected, the target number of target virtual objects from the plurality of virtual objects to be selected, according to a pre-configured accommodated virtual population threshold of the virtual city.

3. The method according to claim 2, wherein in response to the selection instruction for the plurality of virtual objects to be selected, selecting the target number of target virtual objects from the plurality of virtual objects to be selected comprises:
selecting, in response to a selection instruction for a target virtual object inputted according to attribute information of each of the plurality of virtual objects to be selected, the target number of target virtual objects from the plurality of virtual objects to be selected, wherein the attribute information comprises: work type, preset duration for leaving the virtual object residence area, personality description, and figure portrait.

4. The method according to claim 1, wherein generating the demand task associated with at least one virtual object to be selected that is unselected comprises:
generating the demand task according to a pre-configured demand list and demand task generation interval time; and
distributing the demand task to the at least one virtual object to be selected that is unselected.

5. The method according to claim 4, wherein displaying, on the graphical user interface, the task information corresponding to the demand task comprises:
displaying a preset bubble in the graphical user interface, wherein the preset bubble is configured to indicate a current demand task to be completed; and
displaying, in response to a confirmation operation for the preset bubble, demand information and residence duration information corresponding to the current demand task to be completed, on the graphical user interface, wherein the demand information comprises at least one of demanded article or demanded number, and the residence duration information comprises a remaining duration for the virtual objects to leave the virtual object residence area.

6. The method according to claim 4, wherein generating the demand task according to a pre-configured demand list and the demand task generation interval time comprises:
determining the demand task generation interval time according to a level of the virtual city; and
traversing the demand list, and sequentially generating at least one demand order according to the demand task generation interval time.

7. The method according to claim 6, wherein distributing the demand task to the at least one virtual object to be selected that is unselected comprises:
determining a virtual object to be distributed with demand task, according to a configured maximum value of demand tasks allowed to be distributed to each virtual object to be selected and a number of demand tasks currently distributed to the each virtual object to be selected; and
distributing the demand task to the virtual object to be distributed with demand task.

8. The method according to claim 7, wherein determining the virtual object to be distributed with demand task according to the configured maximum value of demand tasks allowed to be distributed to each virtual object to be selected and the number of demand tasks currently distributed to the each virtual object to be selected comprises:
determining whether the number of demand tasks distributed to a target virtual object is less than a maximum value of demand tasks allowed to be distributed, wherein the target virtual object is a virtual object in the at least one virtual object to be selected that is unselected; and
in response to determining that the number of the demand tasks distributed to the target virtual object is less than the maximum value of demand tasks allowed to be distributed, determining the target virtual object as the virtual object to be distributed with demand task.

9. The method according to claim 6, wherein the method further comprises:
discarding a demand task that is currently generated, in response to determining that the number of demand tasks currently distributed to the at least one virtual object to be selected that is unselected reaches the maximum value of demand tasks allowed to be distributed.

10. The method according to claim 9, wherein the method further comprises:
pausing generating a demand task until at least one new virtual object to be selected is generated in the virtual object residence area.

11. The method according to claim 5, wherein in response to completing the demand task, increasing the preset duration for the virtual object to be selected corresponding to the demand task to leave the virtual object residence area comprises:
displaying, in response to completing the demand task, a gain coefficient corresponding to the demand task, on the graphical user interface, wherein the gain coefficient is determined according to the preset duration for the virtual object to be selected to leave the virtual object residence area corresponding to the demand task; and
determining, according to the gain coefficient, a new preset duration for the virtual object to be selected to leave the virtual object residence area corresponding to the demand task.

12. The method according to claim 1, wherein the method further comprises:
generating a task reward, in response to completing the demand task, wherein the task reward comprises at least one of virtual prop or game experience.

13. The method according to claim 1, wherein the plurality of virtual objects to be selected being configured to leave the virtual object residence area after the preset duration comprises:
deleting, in response to determining that a virtual object to be selected is not selected within the preset duration, the virtual object to be selected, from the virtual object residence area.

14. The method according to claim 2, wherein the method further comprises:
increasing, in response to a received virtual city expansion instruction, the pre-configured accommodated virtual population threshold of the virtual city.

15. The method according to claim 1, wherein the method further comprises:
adding, in response to receiving a rescue operation for a virtual object in a game scene, the virtual object that is rescued to the virtual object residence area.

16. (canceled)

17. An electronic device comprising: a processor; a memory, configured to store an executable instruction by the processor, wherein the processor is configured to execute an in-game virtual object control method by executing the executable instruction, the method comprising:
providing a virtual object residence area on a graphical user interface of the electronic device, wherein a plurality of virtual objects to be selected are displayed in the virtual object residence area according to a trigger instruction, and the plurality of virtual objects to be selected are configured to leave the virtual object residence area after a preset duration;
in response to a selection instruction for the plurality of virtual objects to be selected, selecting a target number of target virtual objects from the plurality of virtual objects to be selected, and adding the target number of target virtual objects into a virtual city;
generating a demand task associated with at least one virtual object to be selected that is unselected, and displaying, on the graphical user interface, task information corresponding to the demand task; and
in response to completing the demand task, increasing the preset duration for one of the at least one virtual object to be selected to leave the virtual object residence area corresponding to the demand task.

18. A non-transitory computer-readable storage medium,
wherein the non-transitory storage medium stores thereon instructions that, when executed by a processor of an electronic device, cause the electronic device to perform operations of an in-game virtual object control method, the method comprising:
providing a virtual object residence area on a graphical user interface of a first terminal, wherein a plurality of virtual objects to be selected are displayed in the virtual object residence area according to a trigger instruction, and the plurality of virtual objects to be selected are configured to leave the virtual object residence area after a preset duration;
in response to a selection instruction for the plurality of virtual objects to be selected, selecting a target number of target virtual objects from the plurality of virtual objects to be selected, and adding the target number of target virtual objects into a virtual city;
generating a demand task associated with at least one virtual object to be selected that is unselected, and displaying, on the graphical user interface, task information corresponding to the demand task; and
in response to completing the demand task, increasing the preset duration for one of the at least one virtual object to be selected to leave the virtual object residence area corresponding to the demand task.

19. The electronic device according to claim 17, wherein the processor is further configured to execute:
selecting, in response to the selection instruction for the plurality of virtual objects to be selected, the target number of target virtual objects from the plurality of virtual objects to be selected, according to a pre-configured accommodated virtual population threshold of the virtual city.

20. The electronic device according to claim 17, wherein the processor is further configured to execute:
generating the demand task according to a pre-configured demand list and demand task generation interval time; and
distributing the demand task to the at least one virtual object to be selected that is unselected.

21. The non-transitory computer-readable storage medium according to claim 18, wherein displaying, on the graphical user interface, the task information corresponding to the demand task comprises:
displaying a preset bubble in the graphical user interface, wherein the preset bubble is configured to indicate a current demand task to be completed; and
displaying, in response to a confirmation operation for the preset bubble, demand information and residence duration information corresponding to the current demand task to be completed, on the graphical user interface, wherein the demand information comprises at least one of demanded article or demanded number, and the residence duration information comprises a remaining duration for the virtual objects to leave the virtual object residence area.
